(19) United States
(12) Patent Application Publication
(10) Pub. No.: US 2006/0226577 A1
(43) Pub. Date: Oct. 12, 2006

(54) Method for forming control of composite material product

(76) Inventor: A. P. Lin, Chang HWA City (TW)

Correspondence Address: CHARLES E. BAXLEY, ESQ., 90 JOHN STREET, THIRD FLOOR, NEW YORK, NY, 10038, US

(21) Appl. No.: 11/103,070

(22) Filed: Apr. 11, 2005

(51) Int. Cl. B29C 67/20

(52) U.S. Cl. 264/321

(57) ABSTRACT

A method for forming control of composite material product comprises: adding foam material in predetermined portions of composite material before composite material product being formed, during forming process of the handlebar, the foam material in the composite material will be inflated to produce a stretching force for eliminating undesired deformation of the composite material production. The deformation-resistant composite material product comprises a foam material integrally formed in the composite material product.

### BACKGROUND OF THE INVENTION

1. Field of the Invention

The present invention relates to a method for forming control of composite material product, and more particularly to a method for making a deformation-resistant composite material product.

2. Description of the Prior Arts

Since composite material has the advantages of high strength, high toughness, lightweight and corrosion resistance, composite material products have found a wide application in different fields, such as aviation industry, marine transport, land transport facilities, sports and leisure equipments. However, the composite material products still have the following defects:

Composite material (i.e carbon fiber) products are usually formed in a mould under pressure and heat, during the forming process, the surface of composite material product, especially at the bending portion and the thick portion of the product to be formed, will probably be uneven, or the hole to be formed will probably be deformed, due to the factors of uneven heat dissipation or uneven force. Therefore, the quality of the composite material product will be adversely affected.

The present invention has arisen to mitigate and/or obviate the afore-described disadvantages.

### SUMMARY OF THE INVENTION

The primary objective of the present invention is to provide a method for forming control of composite material product, which can eliminate surface deformation and bore deformation of the composite material product, thus improving the quality of the composite material product.

To achieve this objective, a method is provided in accordance with the present invention to add foam material in predetermined portions of composite material before composite material product being formed, during forming process of the handlebar, the foam material in the composite material will be inflated to produce a stretching force for eliminating undesired deformation of the composite material production.

The secondary objective of the present invention is to provide a deformation-resistant composite material product comprising a foam material integrally formed in the composite material product.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a composite material product in accordance with the present invention;

FIG. 2 is an axial cross sectional view of the composite material product in accordance with the present invention;

FIG. 3 is a traversal cross sectional view of the composite material product in accordance with the present invention;

FIG. 4 is a traversal cross sectional view of the composite material product in accordance with the present invention, wherein the eccentric hole is rectangular shaped in cross section;

FIG. 5 is a traversal cross sectional view of the composite material product in accordance with the present invention, wherein the eccentric hole is elliptical shaped in cross section;

FIG. 6 is a traversal cross sectional view of the composite material product in accordance with the present invention, wherein the eccentric hole is triangular shaped in cross section.

### DETAILED DESCRIPTION OF THE PREFERRED EMBODIMENTS

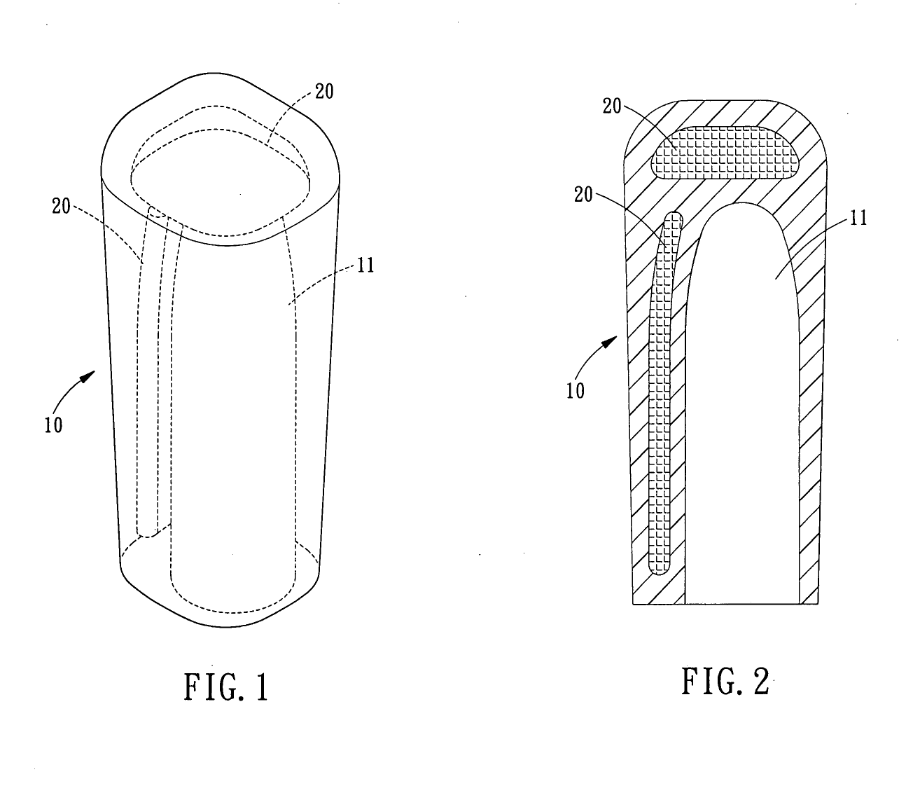

Referring to FIGS. 1-3, a method for forming control of composite material product in accordance with the present invention is illustrated, wherein the composite material product is produced in a mould under pressure and heat. And for example, the composite material product 10 in this embodiment is a bicycle handlebar which is axially formed with an eccentric hole 11 having a circular section, and in a predetermined portion of the composite material is added with foam material before the handlebar is formed.

During the forming process of the handlebar, the foam material set in the composite material will be inflated to produce an outward stretching force, thus eliminating surface deformation and eccentric hole 11 deformation of the composite material product 10 caused by the factors of uneven heat dissipation or uneven force.

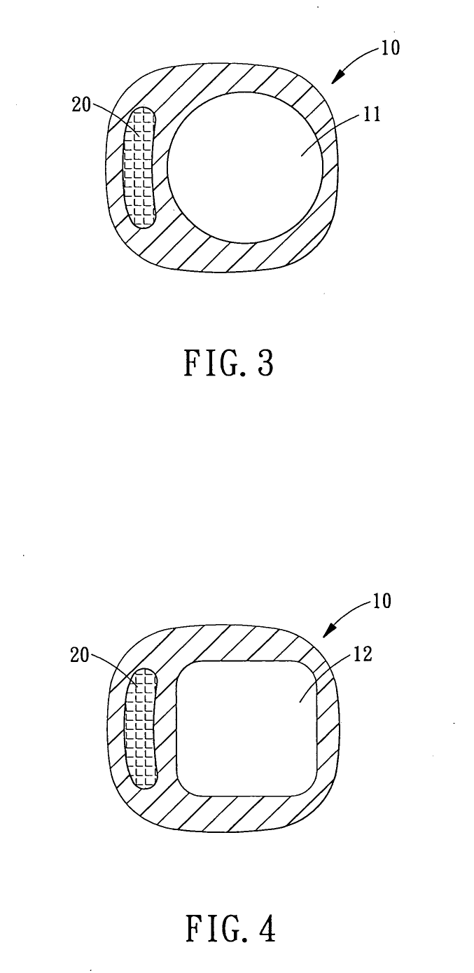

As shown in FIGS. 2 and 3, a deformation-resistant composite material product in accordance with an embodiment of the present invention is a bicycle handlebar which is axially formed with an eccentric hole 11 which is circular in cross section, and in a predetermined portion of the composite material is integrally formed with a foam material 20 which can eliminate surface deformation and eccentric hole 11 deformation of the handlebar caused by the factors of uneven heat dissipation or uneven force, thus improving the quality of the composite material product.

It will be noted that the foam material 20 is located at the bend portion of the composite material product 10, namely, close to the bottom portion of the eccentric hole 11, or the foam material 20 also can be located at the thick portion of the composite material product 10, namely the lateral side of the eccentric hole 11.

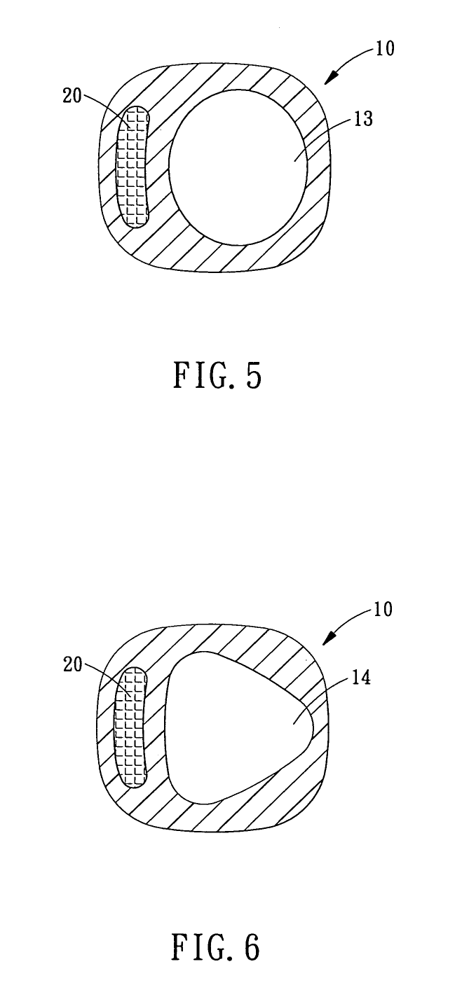

Referring to FIGS. 3-6, a deformation-resistant composite material product 10 in accordance with another embodiment of the present invention is a bicycle handlebar which is axially formed with an eccentric hole 11, 12, 13 and 14. The eccentric hole can be rectangular (as shown in FIG. 4), elliptical (as shown in FIG. 5), triangle (as shown in FIG. 6) or other shapes in cross section.

It will be noted that, in the above-mentioned embodiments, the composite material product 10 is made of composite material blown under pressure in mould, and it also can be made of composite material heated under pressure in mould.

While we have shown and described various embodiments in accordance with the present invention, it should be clear to those skilled in the art that further embodiments may be made without departing from the scope of the present invention.

What is claimed is:

1. A method for forming control of composite material product comprising: adding foam material in predetermined portions of composite material before composite material product being formed, during forming process of the handlebar, the foam material in the composite material will be inflated to produce a stretching force for eliminating undesired deformation of the composite material production.

2. The method for forming control of composite material product as claimed in claim 1, wherein the composite material is carbon fiber.

3. The method for forming control of composite material product as claimed in claim 1, wherein the composite material is made into a product through in-mould blowing and heating under pressure.

4. The method for forming control of composite material product as claimed in claim 1, wherein the foam material will be solidified after being formed and will be covered by the composite material product.

5. The method for forming control of composite material product as claimed in claim 4, wherein the foam material is located at bend portion of the composite material product.

6. The method for forming control of composite material product as claimed in claim 4, wherein the foam material is located at thick portion of the composite material product.
